(19) United States
(12) Patent Application Publication
(10) Pub. No.: US 2002/0001651 A1
(43) Pub. Date: Jan. 3, 2002

(54) Method of altering and improving taste characteristics of edible consumables with monomeric or oligomeric polyphenolic compounds

(76) Inventors: Leslie Marie Norris, Riverbank, CA (US); Jeffrey Dodd McCord, San Raphael, CA (US); Jay M.S. Henis, St, Louis, MO (US); Matthias J. Hoehn, Roedental (DE)

Correspondence Address: Nestor W. Shust, 4616 Granger Road, Fairlawn, OH, 44333, US

(21) Appl. No.: 09/767,123

(22) Filed: Jan. 22, 2001

Related U.S. Application Data
(60) Provisional application No. 60/178,523, filed on Jan. 24, 2000.

(51) Int. Cl. A23L 2/56

(52) U.S. Cl. 426/534

(57) ABSTRACT

This invention is directed to a method of modifying or altering the taste and/or flavor characteristics, such as aromatics, blendedness, creaminess, mouthfeel, fullness, saltiness, sourness, bitterness, onset of initial flavor perception or alcohol perception, of edible consumables, especially brown foods, dairy products, citrus, alcoholic beverages, dietetic foods, low fat foods and fat-free foods, by incorporating in such foods or beverages an effective amount of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

This application claims priority of Provisional Application Ser. No. 60/178,523, filed Jan. 24, 2000.

### BACKGROUND OF THE INVENTION

Materials which add to or change taste or flavor through the impact of their intrinsic properties (spices, herbs, extracts) have been utilized to modify and improve the taste and flavor of edible consumables since the inception of prepared foods and beverages. By “edible consumables” is meant any food or beverage, or any ingredient that may be incorporated in any food or beverage, that is prepared for human or animal consumption. Therefore “edible consumables” include, for example, all types and varieties of prepared or finished compound foods or beverage such as various dairy products, including low-fat or fat-free dairy products, or foods prepared from dairy products or that use dairy products as ingredients; soups or sauces; dressings mayonnaise and spreads including those that are low-fat or fat-free; all varieties of beverages, such as coffee, tea, chocolate drinks, juice drinks, carbonated beverages; alcoholic beverages, including wines, wine coolers, beers, liqueurs, brandies and whiskies. Not intended to be included are artificially prepared or isolated proteins from certain natural products such as whey, albumen and the like and especially soybean that generally do not have distinctive, identifiable flavors. The goal and purpose of employing such materials is to “- - - impart a flavor of choice, to modify a flavor that is already present or to mask some undesirable flavor to increase the acceptability of the end product.” (G. Reineccius, ed., Source Book of Flavors, Aspen Publishers Inc. (1999), pp.1-2).

Since it has become widely recognized that many elements of foods and beverages which impart attractive taste and sensory values also are associated with negative health consequences (e.g. fat, lipids, salt, etc) the value and need for flavor modifiers which can aid in replacing or minimizing the use of such elements in foods or beverages without the loss of positive flavor attributes and acceptability has become even greater. Even more desirable are materials which can improve the taste or related sensory values of edible consumables while also providing positive health benefits to those consuming the food into which such materials have been incorporated.

The earliest and most extensively used food modifiers are spices and herbs. However, more recently specific botanical or protein based isolates have also been used for such purposes. Probably the best known of such flavor modifiers are monosodium glutamate (MSG) and the 5′-ribonucleotides, maltol, ethyl maltol, and hydrolyzed vegetable proteins. Generally such flavor modifiers, whether naturally or synthetically produced, have identifiable flavor characteristics of their own, and may have an effect on taste due to their own flavor characteristics.

For example U.S. Pat. No. 5,077,062 describes the use of soy hydrolyzates as flavor enhancers. In the March 1999 issue of Prepared FOODS, p.79, it has been disclosed that the same flavor enhancer (trade named “Soyarome”) is based on fermented soy flour. U.S. Pat. No. 4,906,480 discloses the use of monomeric polyphenols, particularly flavonoid compounds such as monomeric proanthocyanidin compounds, to enhance (increase the magnitude) and to extend sweetness and flavor by extending the length of time sweetness and flavor are perceived when the said polyphenols are combined with sweeteners in chewing gum. This patent also mentions that said compounds may be used in other foods, such as baked goods, confectionery compositions, beverages, toothpaste, mouthwash, lozenges, syrups, candy and other compositions to enhance and extend the sweetness and flavoring agents contained in such foods.

There are other patents that disclose using flavonols, obtained as a green tea extract which includes catechins, for certain specific food or beverage applications. U.S. Pat. No. 4,946,701 teaches incorporating preferably from 0.05% to 1.0% of such materials in beverages for their physiological benefits. U.S. Pat. Nos. 5,879,733 and 5,902,628 disclose using green tea extracts or tannic acid compounds in beverages to suppress the characteristic aftertaste of aspartame in diet beverages. A technical news article in Chemical & Engineering News, in the Apr. 12, 1999 issue, on pages 47, 49 and 50, reports on certain research activities that have identified the presence of polyphenolic antioxidants known as flavonoids in coffee and chocolate.

Published International Patent Application WO 98/11789 discloses the preparation of “a plant-derived flavonol-containing dry composition suitable for human consumption”. It further discloses that such dry compositions may be added as food supplements to a variety of foods to inhibit platelet aggregation and oxidation of plasma LDL.

A number of disclosures teach the use of proanthocyanidins as dietary supplements in the treatment of various physiological conditions such as irritable bowel syndrome or secondary diarrhea (WO 00/47062 published Aug. 17, 2000); as antiviral agents (U.S. Pat. No. 5,211,944); or the use of polyphenolic microcapsules of antioxidants, preserves and color stabilizers of cosmetics, pharmaceuticals or food compositions (U.S. Pat. No. 5,780,060); or the use of procyanidins extracted from cranberries for inhibiting the adhesion of bacterial cells to surfaces (U.S. Pat. No. 5,646,178). R & D Programs 1997-1998, a collaborative research program between The Australian Wine Research Institute and The University of Adelaide, discloses that the addition of anthocyanins to red wines resulted in “enhanced stability of red pigments”. It further notes that the use of such materials as medicaments for oral consumption “should be useful in the prevention or treatment of coronary heart disease”.

Recently issued U.S. Pat. No. 6,045,849, even discloses the use of proanthocyanidins to improve the flavor of protein isolated from whey or soybean. It is well known, however, that the major challenge with such bare isolated food ingredients is the reduction of bitterness and not the modification of complex flavor characteristics which the isolated protein does not possess. Similarly, Japanese published patent application No. 10004914 (Jan. 13, 1998) discloses the use of proanthocyanidins, such as catechins, in combination with other materials to decrease bitterness or astringency in a food or drink. Interestingly, the prior art does not teach, imply, infer, or disclose using monomeric or oligomeric polyphenols such as proanthocyanidins or other similar phenolic materials to modify, improve, blend or otherwise alter and control the tastes, and even aromas of basic tastes such as salt, sour, bitter, mouthfeel, and other defined sensory notes and characteristics, either alone or as components of the referenced foods.

The extraction and isolation of the monomers and oligomers of the above noted class of compounds has been described in the technical literature and also in a number of patents, including British patent 1,541,469; French patents 968,589; 1,036,922; 1,427,100 and U.S. Pat. Nos. 3,436,407 and 4,698,360.

### SUMMARY OF THE INVENTION

This invention is generally directed to a method of modifying or altering the taste and/or flavor of edible consumables, that is, finished compound foods and beverages, by incorporating therein an effective amount of a monomeric or oligomeric polyphenol (MPP and OPP). Such polyphenols, which include proanthocyanidins (PCs) including monomeric proanthocyanidins (MPCs) and oligomeric proanthocyanidins (OPCs), and other phenolic based monomers and oligomers usually improving the flavor, taste, mouthfeel and character, that is, the sensory qualities of various food systems and selected food ingredients. In some instances this improvement/modification may be accomplished at levels of monomeric or oligomeric polyphenols below the detection threshold of their own sensory characteristics.

This invention is further directed to modifying and improving the flavor, taste and sensory properties of low fat foods and dietetic foods by imparting sensory values normally associated with the full fat and full caloric equivalents of such foods and beverages, using the inventive materials as taste, flavor, mouthfeel, and/or sensory quality modifiers.

These monomeric and oligomeric materials have an unexpectedly strong “positive effect” on the tastes and flavors of many divergent finished foods and beverages. In some instances they impart additional desirable qualities, such as creaminess, body, mouthfeel/fullness, improve blendedness of multiple flavors, decrease the chalky taste of fat substitutes, in particular in low fat desserts, increase the blendedness of low fat salad dressings, enhance lemon/citrus flavors and act generally to improve the overall taste of the foods and materials with which they are combined. At times, this is accomplished, as already indicated, at levels below the detection threshold of the monomeric or oligomeric material itself when tasted in simple solutions. To correctly understand what is meant by this, several concepts are explained below.

The term “detection threshold” means the concentration level at which one may perceive that something other than the standard solution (reference solution) is present, but one cannot taste the intrinsic sensory property of the material that has been added to the standard solution. For example, at the detection threshold of salt in water, one can tell that the solution tastes differently than pure water, but it is not possible to describe the solution as salty.

By “standard solution” or “reference solution” is meant any aqueous standard containing none of the material of known and definable sensible values which may be added at any concentration convenient or appropriate for the subsequent determination of the impact on the reference solution. Thus, a standard or a reference solution may be distilled water or water containing a certain amount of ethanol, such as nine percent (9%).

The “intrinsic sensory taste” means the sensory properties attributable to a particular material that may be sensed or perceived, such as salty for a salt solution.

The “intrinsic sensory taste threshold” means the lowest concentration of a particular material at which one can characterize the sensory properties of that material in a reference solution.

The intrinsic sensory taste properties of monomeric and oligomeric polyphenols (MPPs & OPPs), and especially PCs, in a simple (standard) solution may include astringent mouthfeel and/or the basic taste of bitterness at concentration of 250 ppm and above. Below these levels, these properties are not discernible. By a simple solution in this case is meant a solution of a polyphenolic (PP) material, such as monomeric proanthocyanidins or a PP of some other origin, in distilled water.

It is well known that flavor, as practically defined, (Sensory Evaluation Technique by Meilgaard, Civille, and Carr, CRC Press (1999) pg. 10) is the sum of aromatics, basic tastes and chemical feeling factors. Basic tastes such as salty, bitter etc. are distinguished from aromatic components such as vanilla, maltol, diacetyl, etc. As indicated, the monomeric and oligomeric polyphenolic materials (MPPs & OPPs) of the invention generally have a positive effect on edible consumables and enhance, alter, decrease, increase and/or otherwise change the perceived aromatic components, basic tastes, chemical feeling factors, and flavors associated with said foods and beverages. This is particularly unexpected because, unlike the relatively few other flavor enhancers which are employed to enhance the flavor of foods, these materials do not have “aromatic” properties of their own at any level of concentration. They have only the basic taste and feeling factor characteristics already described.

Another feature of the invention is certain edible consumables containing an effective amount of monomeric or oligomeric polyphenols. The categories include: dairy, alcoholic beverages, low-fat foods, condiments, brown foods, salty foods, and brothy foods.

Yet another aspect of the invention is the modification/altering of flavors and taste notes and texture of complex foods and beverages by incorporating therein a mixture (blend) of monomeric and/or oligomeric PPs and a polymeric polyphenolic material extracted from the same plant material as the MPPs & OPPs are extracted as discussed herein.

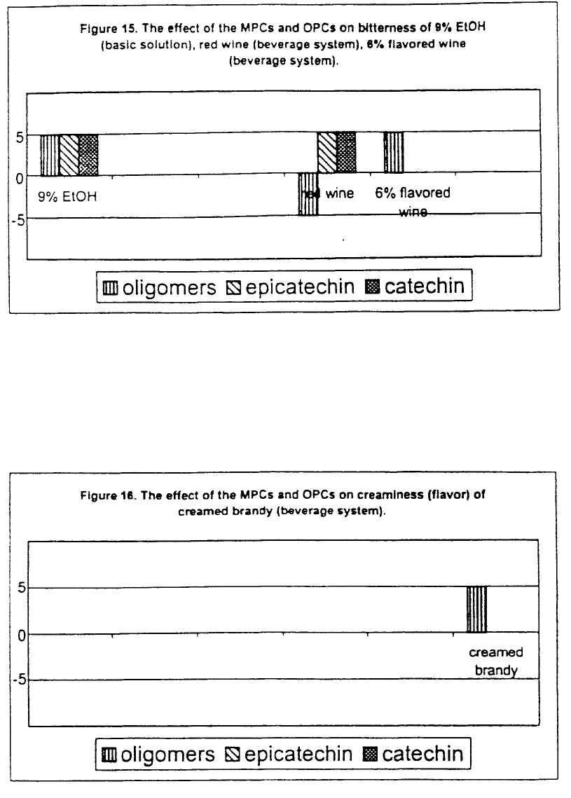

FIGS. 1 to 17 show the effect on the modifyication of various taste characteristics of different food systems by the addition of oligomers, epicatechin and catechin extracted from grape seeds.

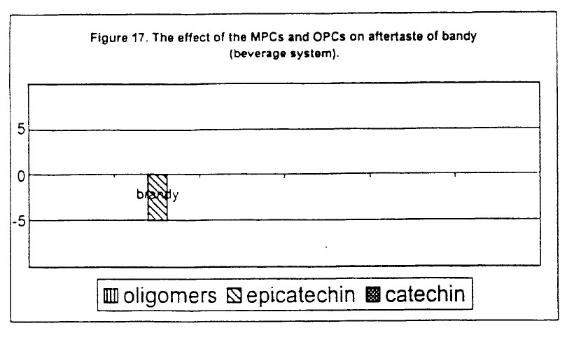

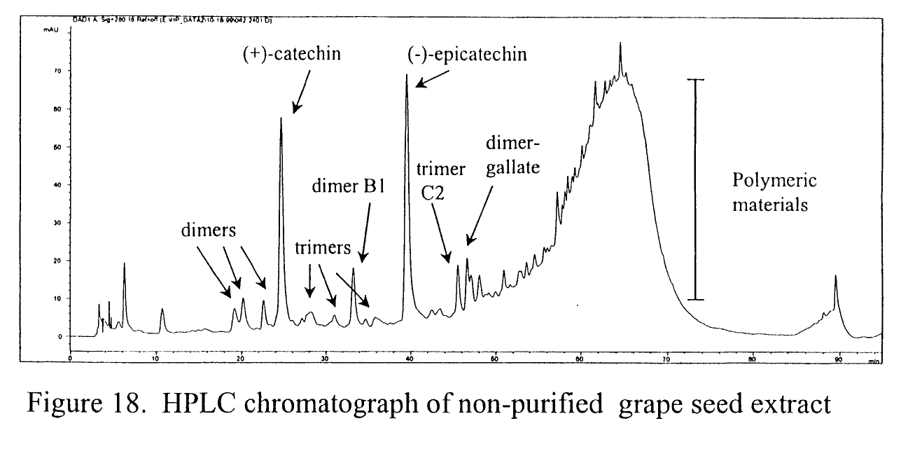

FIG. 18 is a HPLC chromatograph of non-purified grape seed extract.

### DETAILED DESCRIPTION OF THE INVENTION

The present invention deals with a method of improving or modifying/altering the tastes or flavors of finished, compound foods and beverages, said method comprising adding to such foods or an effective amount of a monomeric polyphenol (MPP) or an oligomeric polyphenol (OPP) or a mixture thereof and in particular monomeric and/or oligomeric plant extracts, especially grape seed extracts.

The modification of complex, finished, compound food preparations and beverages must be contrasted from the improvement of bare food ingredients (especially proteins) where, in the case of the latter, the primary aim is reducing bitterness and making them blend so that they do not interfere with the flavor that is added or with the flavor of a finished food to which they are added. The major challenge in modifying finished, compound foods and beverages that contain a complex blend of ingredients producing various flavor and aromatic characteristics is presenting or creating a pleasing, full-bodied, well-balanced and well-blended flavor. The improvement of the taste of a food ingredient versus the modification of a prepared and finished compound food or beverage may be compared to the tuning of an instrument versus balancing the performance of a whole orchestra.

Monomeric and oligomeric polyphenols can be obtained from a variety of plants and fall into two major and one minor groups based on structural characteristics. Major group (I) is the condensed proanthocyanidins. The fundamental structural unit is the phenolic flavan-3-ol (catechin) nucleus, a monomer. The condensed proanthocyanidins exist as oligomers (mostly soluble), containing two to six monomer units and as polymers, containing seven or more monomer units and usually more than ten such units. In most plant tissues the polymers are found in greatest concentration but there are usually a range of soluble molecular species, such as monomers and oligomers. There exists a wide variation in condensation bonding and stereochemistry within this group of polyphenols.

Major group (II) is the galloyl and hexahydroxydiphenoyl acids and their esters. These phenolic compounds are most usually found as multiple esters with D-glucose. These can be further subgrouped into the following subcategories: (i) simple esters; (ii) depside metabolites (gallocatechin, epigallocatechin); (iii) hexahydroxydiphenol and dehydrohexahydroxydiphenoyl esters (ellagitannins); (iv) dimers and higher oligomers formed from oxidative coupling of monomers, most often those of class (iii). The third and relatively minor class is the phlorotannins, isolated from several genera or red-brown algae. They are distinguished by the presence of C—C and C—O bonds.

In the literature, the polyphenolic materials employed in the present invention are often and variously referred to as condensed tannins or non-hydrolyzable tannins. Such compounds contain the fundamental structural unit, flavan-3-ol, as well as hydroxyflavan-3,4-diols, and include such monomeric compounds as catechins. Such materials occur naturally as monomers, oligomers and polymers but they may also be prepared synthetically. According to the definition used hereunder, and generally used in the literature, the oligomers usually contain two or three monomeric repeat units, but the higher molecular weight oligomers contain up to five and possibly even up to six condensed flavan-3-ol units. As used herein, oligomeric materials include both the lower and the higher oligomers. The polymers contain seven or more condensed flavan-3-ol units and especially ten or more such units. These secondary plant metabolites are widely distributed in various species of the higher plant kingdom and may be extracted from numerous plant materials and tissues, such as, pine bark, lemon tree bark, grape seeds, grape skins, grape stems, cranberries, green tea, hazel nut tree leaves, blue berries, cherries, strawberries, apples and other fruits and plants including grains such as barley and various parts of such plants generally referred to as seeds, skin of fruits or berries, bark, and endocarp. The most important sources of such materials are various parts of the grape, especially seeds, stems and skins.

Examples of these polyphenolic compounds are epicatechin, gallocatechin, epigallocatechin, leucoanthocyanins, anthocyanidins, procyanidins, prodelphinidins, cyanidins and other compounds of this category. An extensive and authoritative discussion of this class of compounds may be found in Practical Polyphenolics by E. Haslam, Cambridge University Press, 1998. Polyphenolic monomers and oligomers may also be obtained from raw, untoasted oak. This class of compounds has a carbohydrate backbone with gallic acid moiety esterified to variable degrees. The three major subunits of these polyphenolic compounds are gallic acid, carbohydrate and ellagic acid (a gallic acid dimer). Other forms of isolated monomeric and oligomeric polyphenolic materials (other than the proanthocyanidins) which are similar to them are generally known to exist in nature and also may be present in many plants, parts of plants, and plant tissue. However, they have not been analytically or chemically well characterized and their sensory properties have not been well identified or reported.

The crude extract of the materials of the invention is obtained from their natural sources by first processing the source material with aqueous solvents, including those containing miscible organic co-solvents (such as, but not limited to, acetone and ethanol). This treatment yields a crude extract, which, upon further separation and processing, yields the desired PPs. Further isolation and purification may be achieved using a sequence of dissolutions and precipitations and drying methods known in the art. Extraction and isolation of the lower molecular weight PPs, such as the monomers and oligomers, have been described in the prior art as mentioned above. The isolated PPs, even after several purification steps such as by successive dissolutions and precipitations, are not specific singe polyphenolic compounds or oligomers. Rather, they are still complex mixtures of PPs that apparently also contain other compounds that have not yet been identified. The presence of such other compounds or materials may be responsible for the fact that PPs isolated from different plant materials may have different flavor modification/altering properties.

The polyphenolic materials that would be identified according to this invention as monomeric will most likely contain a small amount (such as up to 2% or possibly even up to 10%) of oligomers and even some polyphenolic polymers (such as up to 1%, 2% or possibly even slightly higher amounts). Similarly, polyphenolic materials that would be identified according to this invention as oligomeric will most likely contain a small amount of monomers (such as up to about 15% or possibly slightly more) and some polyphenolic polymers (such as up to 2% or 3% or even up to 5%). The exact amount of such other polyphenolic materials that may be present will primarily depend on the degree of purification that is carried out. If purification employs dissolutions and precipitations, the purity of the desired polyphenolic material is increased with each cycle. If molecular membranes are employed, the quality of the membrane and the number of passes through the membrane will determine the degree of the purity.

The process for obtaining the crude extract are characterized by the following steps for catechin based monomers and oligomers (including MPCs from grape seed) and may be extended to other compounds of the polyphenolic class obtained from various plant matter and different sources:

1) Extraction of the proanthocyanidin-containing material with mixtures of water and acetone or ethanol, until exhaustion of the proanthocyanidins. If precipitation is to be used in the next step, wherein hexane, liquid propane, or the like is the precipitant, and 80-85% aqueous ethanol or ethanol solutions containing up to 100% ethanol may be used as the solvent. If however, precipitation is not used in the next step, 20% or 10% or even water alone may be used as the aqueous solvent. Although concentrations of ethanol as high as 90% are permitted, even azeotropic or 100% ethanol may be used. If the solutions contain no ethanol or low content ethanol (up to 40%), longer exposure times and higher temperatures are useful to obtain maximum yield from the polyphenol or proanthocyanidin feedstock. The solvents and precipitants chosen must be compatible with each other and, from a practical standpoint, must be acceptable for food grade processing. Hence, any solvent and any precipitant having current GRAS approval and/or currently used and accepted in the production of foods (e.g. ethyl acetate) may be useful in the extraction and separation, provided that it can dissolve the desired material under conditions which do not degrade its useful properties.

2) If an organic solvent is present, the extract is concentrated by evaporation under vacuum until the organic phase is removed. Water must be removed under conditions sufficiently mild to avoid undesirable chemical changes in the extracted proanthocyanidins or other polyphenolics. Freeze-drying of the extract to remove water is the method of choice, but other methods such as spray drying at any acceptable temperature which does not harm the extracted material, or negatively impact its useful properties, are also useful. In this regard 75-85 degrees C. may be a useful temperature maximum. After isolation of proanthocyanidins or polyphenols by what are effectively one or several sequential prior art methods, a wide mixture of the monomeric, oligomeric, polymeric materials will be present along with many undesirable contaminants from the natural source material. Purification and separation to remove most of these undesirable materials and the polymers is then necessary.

The purification or isolation methods comprise:

1) Precipitation and Adsorption

a) Dissolving the dried extract of proanthocyanidins or other polyphenolics in an aqueous solvent containing preferably 80 to 95% ethanol, but possibly also containing more or less of such an organic solvent up to 100% ethanol, and filtering the solution in order to remove solid particles;

b) Adding hexane or some other suitable precipitant which is immiscible with the aqueous solvent, to the filtered solution to precipitate;

c) Isolating the supernatant (containing MPCs and OPCs) material by methods such as filtration, centrifugation, or settling; collecting by decanting;

d) Drying the resulting desirable MPCs and OPCs of the invention to substantial dryness, generally containing less than 8% water and preferably less than 5% of water and most preferably less than 1% of water, yielding the dried MPC and OPC composition of this invention;

2) Membranes

a) The extract from whole or cut seeds with or without concentration is exposed to various molecular weight cut-off membranes;

b) The material retained by the 10 K membrane is the PPC fraction;

c) The material that permeates through the above membrane is then exposed to a nominally 1K membrane;

d) The material retained by the 1 K membrane is the OPC fraction;

e) The material that permeates through the 1 K membrane is the MPC fraction;

f) Drying the resulting desirable MPCs and OPCs of the invention to substantial dryness, generally containing less than 8% water and preferably less than 5% of water and most preferably less than 1% of water, yielding the dried MPC and OPC composition of this invention.

Monomeric and oligomeric polyphenols may be prepared synthetically. A number of routes for the synthesis of phenolic monomers and polymers, including oligomers, have been reported in the literature. Most synthetic routes relate to their use as adhesives and plastics. Other reports are related to plant and/or animal enzyme catalyzed polymerization, e.g. tanning of the skin. The methods for production of synthetic OPCs and PPCs will include, but not be exclusive, to the following.

1. Enzyme catalyzed initiation of polymerization. These may include polyphenol oxidase, peroxidases, lipoxygenases, though oxo-reducatase and oxidase enyzmes may induce similar polymerizations.

2. Metal catalyzed polymerization. These might include the use of Fe, Cu, Mn, and Mg, although other ions may induce similar initiation reactions for polymerization of the starting phenolic substrates.

3. Crosslinking/bridging reactions. This would utilize chemical compounds such as glutraldehyde, acetaldehyde and other similar compounds capable of crosslinking two compounds.

Basic or acidic conditions may be utilized alone or in combination with the above mentioned catalysis methods. Strong basic conditions are known to cause polymerization of phenolic compounds. As well, acidic conditions are capable of catalyzing reactions, although the rate of reaction may differ substantially and vastly different products may be formed.

The truly surprising positive effect that MPPs and OPPs have on the taste and flavor of prepared compound foods and beverages is very complex and not yet understood. Although it has been found, and it is the essence of this invention, that monomeric and oligomeric polyphenols generally modify/alter the flavor and taste of foods and beverages, it is often not possible to predict exactly which characteristic, feature or note of a particular flavor will be modified. Thus the MPPs and OPPs may modify or alter certain notes or basic tastes or bring out or create still other notes that were totally absent or not observed in the unmodified original food product. These polyphenolic compounds change the flavor profile. The modification/altering of flavors, tastes or notes of these materials are flavor system dependent, that is, involve the complex integration of a variety of basic tastes (salty, sour, bitter, sweet and umami) and of the many aromatic flavor notes that are present in a particular food product. Thus, specific notes will be modified while other new notes may be created. For example, if MPPs are added to a beverage resulting in the modification of sourness and fullness, it is not possible to re-create the MPP modified beverage by merely increasing citric acid. New attributes are formed by the addition of the MPP that were not present in the original food or beverage and some taste features are blended or “rounded” so that a new and complex flavor is evolved.

It is important to note the distinction between “flavor enhancement”, “flavor extension” and “flavor modification”. When flavor or a basic taste is enhanced, the flavor or taste is stronger, more pronounced; when it is “extended”, the flavor or taste is perceived for a longer period of time. In both instances the taste is not modified, altered or changed, i.e., no new flavor attributes, characteristics or notes are observed and the quality of taste remains approximately the same (without noticeable changes in such qualities as smoothness, blendedness or creaminess), although stronger or longer. On the other hand, when the taste or flavor is “modified” or “altered”, some individual flavors and basic tastes are increased or decreased resulting in a changed flavor profile. The modification may bring out and/or create new attributes based on a new synergy that has occurred due to the addition of the MPPs and OPPs. This invention is directed to the modification/alteration of tastes and flavors resulting in a changed flavor profile and not to the enhancement or extension of tastes and flavors. Because of the complexity of the modification mechanism, there may be some incidental enhancement or extension of flavor attributes (notes) in addition to the desired modification.

The major challenge in the modification of taste or flavor of finished, compound foods are beverages is presenting a pleasing, full-bodied, well-balanced and well-blended flavor. This usually involves the modification of various flavor characteristics, such as aromatics, creaminess, mouthfeel, saltiness, sourness, sweetness, bitterness, timing of the initial perception of a particular flavor or a combination of flavors, perception of the level of alcohol, and the well-blended or blendedness and full-bodied or fullness of the tastability of flavor. Such a complex combination of taste characteristics is not involved when a food ingredient, such as an isolated protein, is modified to reduce a particular undesirable characteristic, such as bitterness.

The modification or positive effect on flavors, taste notes and texture in foods or beverages by MPPs and OPPs is sometimes achieved even when used at or below their intrinsic detection threshold and definitely below their intrinsic sensory taste property threshold. By a “positive effect” is meant a better quality of taste and not necessarily an increase in a particular defined characteristic. A positive effect in food modification may in fact include a decrease in some undesired characteristic, such as bitterness, sourness, chalkiness, or unpleasant mouthfeel. According to the present invention, the flavor modification and positive effect are achieved even though the particular modifier itself may have a bitter taste when used in concentrations higher than its intrinsic sensory property threshold (500 ppm in the case of OPCs) and may have no perceptible intrinsic bitter/astringent taste when used at lower concentration. Such effects are particularly noticeable when the polyphenolic materials are utilized in complex food preparations. Another unusual characteristic of these monomeric and oligomeric materials is their ability to move some taste characteristics in the mouth so that they are perceived in a different region from where they otherwise would be perceived, or in still another manifestation, in spreading the taste throughout the oral cavity so that its overall perception is altered either spatially, characteristically, or both. In addition the MPPs and OPPs can change the rate at which taste attributes are perceived. All of these properties work together to allow the MPPs and OPPs of the invention to blend different sensory characteristics to present a more appealing or more natural taste in the food or beverage being modified.

The polyphenolic materials of this invention may be successfully employed above or in combination with seasonings, natural or artificial flavorings or adjuvants. The unusual benefit of such combinations is that it is possible to obtain unique organoleptic properties or sensations otherwise not attainable and often it may not be necessary to use the same amount of such seasonings or even all the seasonings that otherwise would normally be used.

The inventive properties of the monomers and oligomers are related to the number of repeat units they contain, their hydrophobicity and the degree to which they interact with, complex with, or cause protein to precipitate in the mouth, other flavor and taste elements in food and the specific source of the monomers/oligomers which relates to the chemical structure of the monomer and the presence of additional unidentified compounds which may have a synergistic effect in combination with the MPPs and OPPs.

There may be other compounds besides the specific MPCs and OPCs or other MPPs and OPPs discussed, especially in toasted oak, which are at least partially responsible for these effects. Such other compounds may be derived from the breakdown of lignin, hemicellulose and other carbohydrate polymers during the toasting process. The phenyl propane subunits of lignin can be oxidized with heat to form a variety of compounds, which include vanillin, vanillic acid, syringaldehyde and syringic acid to name a few. The hemicellulose and other carbohydrate polymers may form furfural, hydroxymethyl furfural and 5-methyl furfural. These compounds, as monomers, and many others are responsible for odor and flavor from toasted oak but may undergo further reactions, such as condensation, to form large molecules with the above noted food-related properties.

The extraction of oak employing prior art process steps yields a complex mixture of largely polymeric materials, but also an appreciable amount of monomeric and oligomeric polyphenols. Sensory panel testing on the same food products and basic tastes indicated that the behavior of these polyphenolics is essentially the same as of the PCs from grape seeds discussed above.

Monomeric and oligomeric phenolics can be isolated from oak by first shredding the wood and then processing it in the same manner as described above with respect to the extraction and isolation of proanthocyanidins from grape seeds. The monomeric and oligomeric materials may be isolated from the polymers as mentioned above.

The MPC and OPC compositions extracted and isolated as described above can be characterized by the following methods:

High Performance Liquid Chromatography (HPLC)—lower molecular weight MPCs and OPCs are resolved as distinct peaks in the chromatogram under the conditions described below (see also FIG. 18):

1) Catechin peak (approximately 26 minutes) is greater than 0.15, preferably greater than 0.30, and most preferably greater than 1;

2) Epicatechin peak (approximately 41 minutes) is greater than 0.10, preferably greater than 0.2, and most preferably greater than 1;

3) Proanthocyanidin peak (approximately 22 minutes) is greater than 0.65, preferably greater than 1.3, and most preferably greater than 3;

4) Proanthocyanidin dimer peak (approximately 35 minutes) is greater than 0.35, more preferably great than 0.70, and most preferably greater than 2.5; and

5) Proanthocyanidin trimer peak (approximately 47 minutes) is greater than 0.6, more preferably greater than 1.2, and most preferably greater than 3;

Under the following analytical conditions:

1) Instrument: Hewlett Packard HP 1100 Series

2) Column: Zorbax SB-C18, 4.6×150 mm, 3.5 micron, 80 A pore size

3) Column Temperature: 30° C.

4) Column Pressure (max): 200 bar

5) Solvent gradient:

Solvent A: 2.5% acetic acid

Solvent B: 80% acetonitrile in solvent A

| | | | |
|---|---|---|---|
| 0-3 | min | 3% | solvent B |
| 3-25 | min | 9% | solvent B |
| 25-35 | min | 11% | solvent B |
| 35-50 | min | 20% | solvent B |
| 50-62 | min | 35% | solvent B |
| 62-70 | min | 40% | solvent B |
| 70-80 | min | 60% | solvent B |
| 80-85 | min | 100% | solvent B |
| 85-90 | min | 100% | solvent B |
| 90-100 | min | 3% | solvent B |
| 100-105 | min | 3% | solvent B |

6) Solvent Flow rate: 0.5 ml/min

7) Injection: 25 ml direct injection of a grape seed extract sample

8) Detector: Diode array detector with an analytical flow cell

Detection wavelength: 280 nm, bandwidth 16, scan 220-400 nm.

The OPPs and MPPs useful in this invention are usually isolated from raw, unfermented material stock, but at times the plant material, such as the grape seeds, may be fermented. The PPs extracted from the fermented materials are chemically substantially the same as those extracted from the unfermented materials. That is, the molecular weight of the PPs and the relative proportion of the monomers, oligomers and polymers are substantially the same in the extract from the unfermented as well as from the fermented plant materials. Generally, the water-extracted material will contain a greater amount of monomers and oligomers than of polymers. If solvents, such as alcohol, are used in combination with water, the extract will contain a greater amount of polymeric PPs, which must be separated. Similarly, crushed grape seeds will yield a greater amount of polymeric PPs than the non-crushed seeds. At times the plant material, especially oak, is toasted (i.e., heat-treated). This treatment also, in principle, does not alter the chemical content of the polyphenolics.

The present invention provides that monomeric or oligomeric polyphenolic materials. or a mixture thereof, may be employed to modify various flavor characteristics of edible consumables. It may be advantageous for a variety of reasons to employ a mixture of monomeric and oligomeric polyphenolic materials. Such mixtures may contain from 5% of one type of phenolic material to 95% of the other. Often 20% to 80% of one and 80% to 20% of the other may be useful and practical and a 50/50 mixture may also be very convenient in achieving the desired flavor modification.

A further unique feature of the invention is the synergistic effectiveness in modifying/altering the flavor and taste characteristics and properties of edible consumables when monomeric and/or oligomeric polyphenolics are used in combination (blends) with polymeric polyphenolics which are fully described in copending patent application Ser. No. 09/634,611, filed Aug. 5, 2000, which is incorporated herein by reference. The monomeric/oligomeric PPs and the polymeric PPs may each be used in the amount of from 0.0005% (5 ppm) and often from 0.001% (10 ppm) or from 0.002% (20 ppm) to 0.1% (1000 ppm) by weight based on the weight of the food product or beverage to be modified. Preferably the amount of each of the monomer/oligomer and of the polymer used is from 0.005% to 0.05% (50 to 500 ppm). The ratio of the monomer/oligomer to the polymer may be from 20% to 80% of one to 80% to 20% of the other. It is often convenient to use a 50/50 mixture of the monomer/oligomer and the polymer. The above discussed mixtures of polyphenolic materials, including mixtures of monomeric, oligomeric and polymeric materials may be especially useful in achieving a particular balance in the modification of various taste characteristics such as of aromatics, blendedness, creaminess, mouthfeel, fullness, saltiness, bitterness, the initial onset of a particular flavor perception or of alcohol perception. Different food systems may respond differently to various molecular weights of the polyphenolics. Therefore it may require some experimentation to identify a specific mixture of polyphenolic materials to attain the desired modification of certain flavor characteristics of a particular food system.

An example of the synergistic effectiveness of the blend of a monomer/oligomer and a polymer in food modification was demonstrated when 100 ppm of epicatechin and 100 ppm of a polymer of epicatechin and catechin were added to Hunts® Ready to Eat Banana Pudding. This mixture of PPs increased blendedness, creaminess and dairy notes and improved mouthfeel and decreased the artificial banana flavor. However, when epicatechin was used alone, there was creaminess but no change in artificial banana flavor. Similarly, when the polymeric epicatechin-catechin was used alone, a slight increase in creaminess and a large decrease in artificial banana flavor were observed.

In the method of this invention monomeric and oligomeric polyphenols such as proanthocyanidins and other OPPs and MPPs obtained from oak must be added to an edible consumable in an effective amount to enhance, improve or modify the taste or flavor to a desired degree. If an insufficient amount of such material is added, the taste may not be sufficiently modified to be noticed, especially by some people who may be less sensitive to a particular taste change. If too much of the polymer is added, an undesirable taste may develop and/or it may not be economical to use larger amounts because a greater amount of MPP and OPPs would be added than is necessary or efficient from a cost/performance standpoint.

The optimal amount may be expected to differ for each food or beverage and may also depend on the feature of the flavor or taste that one desires to modify or bring out. For this reason it is difficult to give one range of the amount of a monomeric or oligomeric polyphenol that should be appropriately added to foods or beverages in general to obtain the desired modification or improvement of a particular taste, flavor or sensory characteristic. It is necessary to conduct taste trials to identify the dose and preferred range of a polyphenolic of the invention that should be added to a particular food or beverage to give the desired sensory results. The need for such routine testing to determine the optimum amount of a food additive is common in the food and beverage industries. It nevertheless may be generally stated that modification of various sensory properties in an edible consumable may be attained by incorporating in such consumables from about 0.0001% to about 0.1% by weight (1 ppm to 1000 ppm) of a polyphenolic of this invention that is especially the polyphenolic composition isolated from grape seeds. such polyphenolic compositions will include monometic compounds or oligomers thereof or a mixture of such monomers and oligomers or any mixture of monomers and/or oligomers with polymeric polyphenols containing seven (7) or more repeat units and often at least ten (10) such units. The above stated weight of a polyphenolic material is based on the weight of the edible consumable the sensory properties of which is being modified to a solid food it may be appropriate to add from 0.0005% to 0.10% by weight (5 ppm to 1,000 ppm) and preferably from 0.00075% to 0.05% by weight (7.5 ppm to 500 ppm). Often 0.001% to 0.025% by weight (10 ppm to 250 ppm) is a useful and effective amount. The amount that is often effective in liquids is from 5 ppm to 500 ppm, preferably from 10 or 20 ppm to 100 ppm, especially when used in liquids.

In another aspect of the invention, the addition of from about 5 ppm to about 2,500 ppm and more, often from about 10 ppm to about 1,000 ppm and conveniently from 20 ppm to 200 ppm of a MPP such as a MPC to a beverage containing from less than 0.1% to up to 80% of alcohol such as between 0.1% and 2.0% alcohol or between 2% and 5% alcohol or between 5% and 14% alcohol or between 14% and 20% alcohol or between 20% and 40% alcohol or even between 40% and 80% alcohol, will alter and/or improve the sensory characteristics of an alcoholic beverage such as mouthfeel, body, fullness and/or blendedness.

Generally, a food that has an off-note, an undesirable attribute, may be improved in flavor and taste by adding an appropriate and effective amount of a monomeric or oligomeric polyphenol such as proanthocyanidin. Low-fat or reduced fat foods containing fat substitutes often have an undesirable chalkiness. This chalkiness be decreased or totally eliminated by the addition of an appropriate amount of, for example, OPCs.

If a low alcohol beverage, such as a low alcohol cooler or other low alcohol wine drink is very sweet with a thin, watery mouthfeel, OPPs such as OPCs can increase the perception of alcohol, body, blendedness (uniformity of taste) and mouthfeel, while decreasing sweetness and potentiating fruity wine aromas. In addition to low alcohol wines it has been shown that PPs add a significant component of higher alcohol content taste without actually increasing the alcohol content.

Further, when added to both low alcohol and other flavored and composed wines, PCs, monomeric or oligomeric oak extracts and generally PPs in effective amounts have been shown to increase the blending of flavors and give a more natural taste and mouthfeel to a beverage.

The specific effect that monomeric and/or oligomeric polyphenols may have on foods and beverages will depend on the chemical nature of the polyphenolic compound or compounds, the molecular weight, the source of the polyphenolic compound(s) and the specific food or beverage to which a PP is added. As mentioned above, the modification of the taste and flavor of foods and beverages is very complex, not yet well understood and at least at this time not susceptible to generalizations. This may be best illustrated by the following examples that show unexpected and unpredictable modification of tastes and flavors of different complex foods.

For a typical MPC or OPC sample taste evaluation, the solid samples are dissolved in a 50:50 ethanol:water to give a concentration of 5% (50,000 ppm). Deionized water is used to make the 5% solutions. Using the 5% solution, taste samples are prepared to contain 750 ppm in the food or beverage to be taste evaluated. The samples are appropriately labeled to ensure that the samples are tasted blind and are not mixed up. Three trained panelists taste the samples and use a 15-cm line scale to record findings. There is a 3-minute period between each sample tasting in which the panelist rinses with 0.5 M sugar solution, drinks water, and eats a cracker.

The following food systems and beverage systems were used as model systems for the evaluation of the modification properties of MPCs and OPCs when added below the intrinsic sensory taste threshold.

TABLE 1
Food Systems Utilized to study the effects of MPCs and
OPCs on basic tastes, aromatics, and mouthfeel.

| | |
|---|---|
| Non alcohol | |
| salad dressing | Hidden Valley ® Light Original Ranch Dressing |
| cheese | Kraft ® Reduced Fat 2% Milk Mild Cheddar |
| | Cheese |
| banana yogurt | Yoplait Original ® 99% Fat Free Banana Cr\overline{e}me |
| lemon yogurt | Yoplait Original ® 99% Fat Free Lemon Burst |
| lemon icing | Betty Crocker ® Fluffy and Light Soft Whipped |
| | Frosting Lemon |
| lowfat chocolate icing | Betty Crocker ® Reduced Fat Chocolate Frosting |
| | Sweet Rewards |
| ice cream | Hagen Daaz ® Lowfat Coffee Fudge Ice Cream |
| diet coke | Diet Coke ® |
| lemon beverage | Storm ® |
| jelly | Knott's Berry Farm ® Light Boysenberry |
| | Preserves |
| banana pudding | Hunt's Snack Pack ® Puddin' Pies Banana |
| | Cream Pie |
| sour | 0.1% Citric Acid in water |
| red pepper | 0.1% Red Pepper in water |
| Alcohol | |
| 9% EtOH | 9% EtoH in water |
| Brandy | Original Extra Smooth E&J ® Brandy |
| White Wine | Turning Leaf ® California Chardonnay 1997 |
| Red Wine | Turning Leaf ® California Cabernet Sauvignon |
| | 1997 |
| Creamed Brandy | E&J ® Cask & Cream Liqueur Fine Brandy and |
| | Cream |

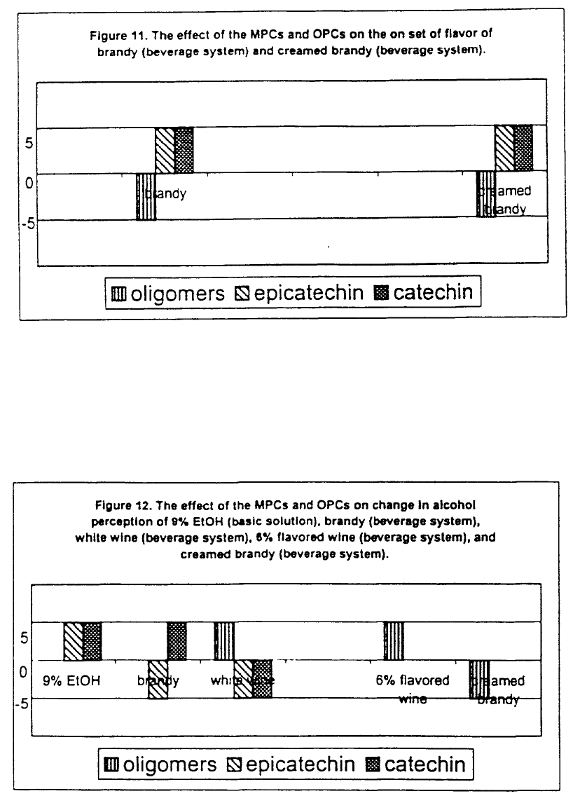

The OPCs and MPCs were screened in the food/beverage systems listed in Table 1 above at levels from 20-200 ppm, and the alcoholic beverage systems listed in Table 1 at 10-100 ppm. Both the food and the beverage systems were modified at different modifier concentrations. FIGS. 1-10 depict food systems with the addition of 100 ppm MPCs and/or OPCs. FIGS. 11-17 depict the alcoholic beverage systems with the addition of 30 ppm OPCs and/or MPCs. The Figures appear at the end of the specification.

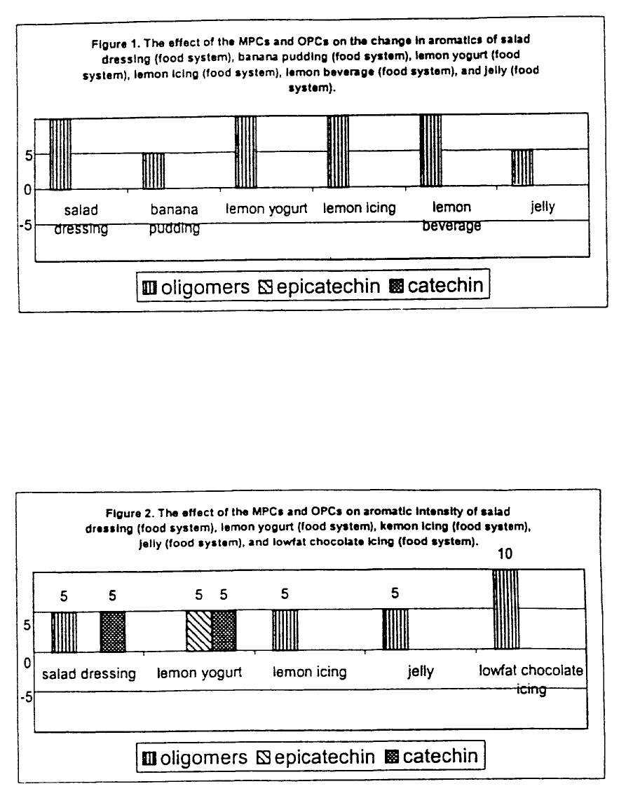

FIG. 1 depicts the change in the aromatics of many food products. As previously stated, the MPCs and OPC do not simply increase the aromatics (volatile flavor chemicals) of the product; they modify the aromatics. For example, the addition of OPCs to the salad dressing resulted in a more mayonnaise-like product, the lemon yogurt and lemon icing changed from a candied lemon to a fresh, juicy lemon taste. The chocolate icing became fudgy, instead of cocoa-like, and the jam had a fresher berry note. In addition, for some products the modified aromatics were also found to increase. Therefore, aromatics increase in intensity for salad dressing would mean a higher mayonnaise type flavor; for lemon yogurt and lemon icing a stronger fresh lemon flavor; for jelly, a fresher and stronger berry flavor; and for low-fat chocolate icing, a stronger fudge character vs the cocoa character found in the untreated sample (FIG. 2).

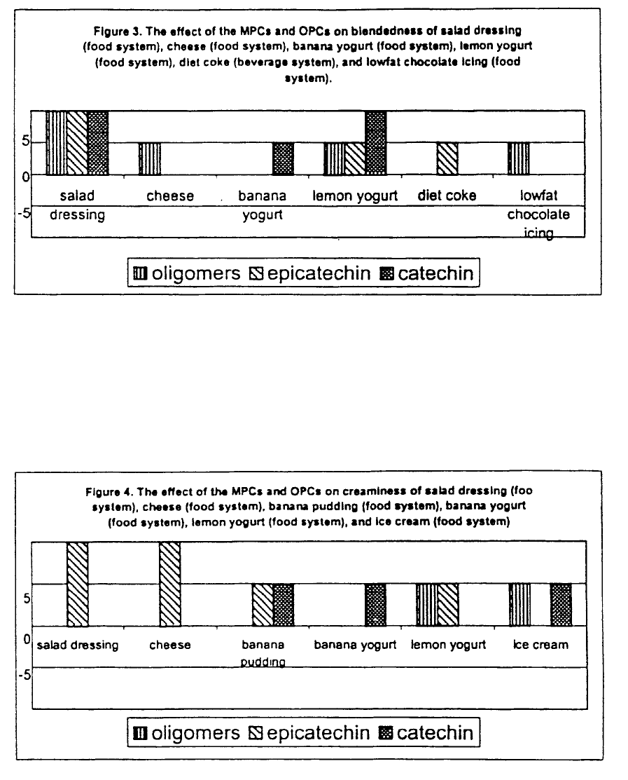

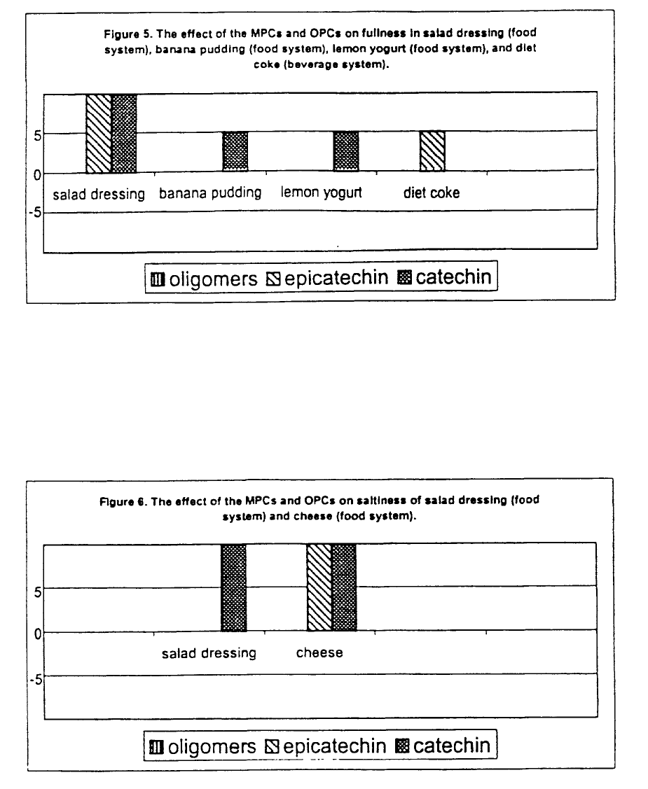

Blendedness is a term that describes the way in which all of the flavor attributes combine to give a certain food its character. Traditionally, the more blended a product, the higher quality and the more a product is preferred. Low-fat products are often deemed unblended as the fat is no longer present to “carry/combine” the flavor attributes. The MPCs and OPCs can increase the blendedness of a product (FIG. 3) and in most cases the creaminess of a product (FIG. 4). Fullness relates to the mouthfeel of a product. The MPCs and OPCs can be used to increase the fullness (vs thinness) of a product (FIG. 5). This is again important in dietetic (no sugar) products and low-fat products where the mouthfeel of the product becomes thin due to the replacement of sugar with non-caloric sweeteners and or the replacement of fat with non caloric substitutes.

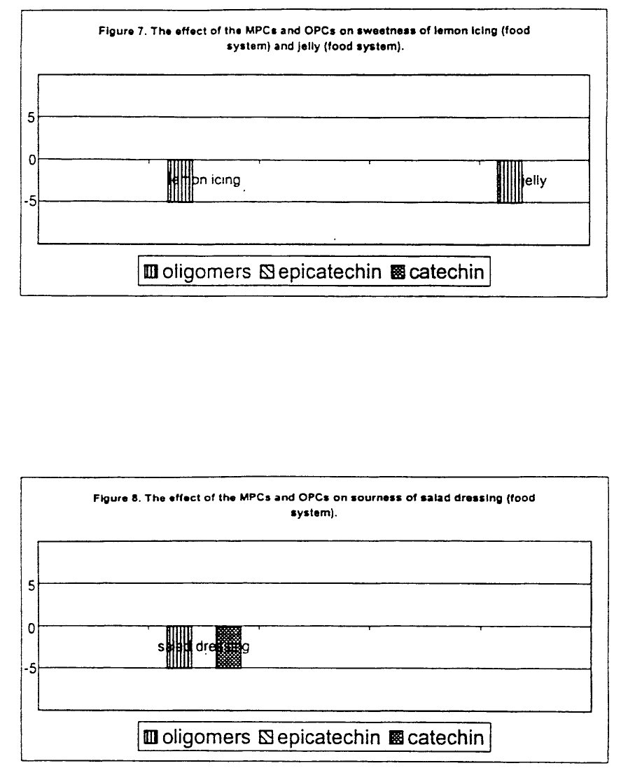

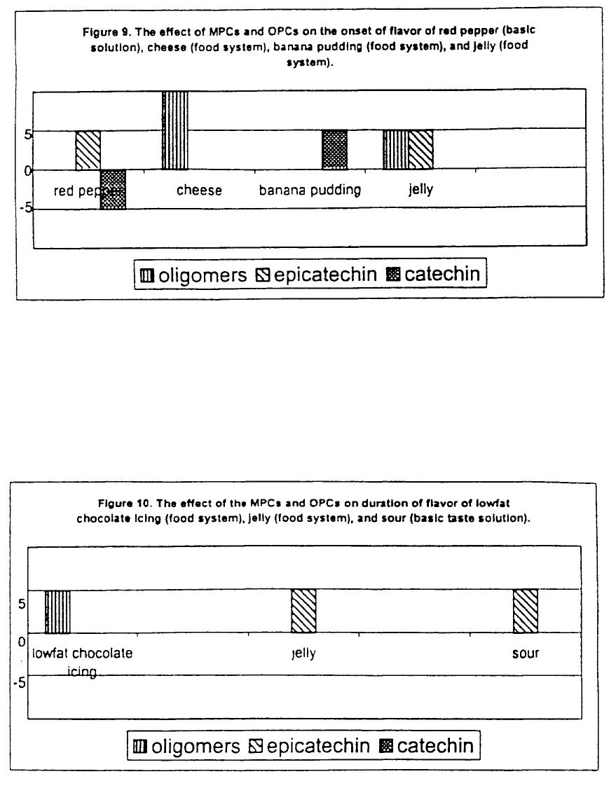

In some food products an increase of some of the basic tastes (saltiness in salad dressing and cheese, FIG. 6), and a decrease in other basic tastes (sweetness in lemon icing and jelly, FIG. 7) and a decrease in sourness (in salad dressing, FIG. 8).

The other observation that was made was that the addition of speed at which the flavor is perceived may change as well as the duration with which the flavor is perceived. For red pepper, catechin decreased the speed at which heat was sensed while epicatechin increased the speed at which red pepper was sensed. For low-fat cheese, the addition of OPCs decreased the length of time necessary to perceive the flavor (FIG. 9).

In some food products, the flavor was extended. For example, with the addition of OPCs, the chocolate fudge character of low-fat chocolate icing was extended (FIG. 10).

Monomeric PPs such as proanthocyanidins and oak extracts are generally soluble in aqueous solution, depending on the specific nature of the monomeric unit. However, the oligomeric PPs, especially those having four to six repeat units, depending on their molecular confirmation, functional substitution and other structural elements may be less soluble in water. However, such solubility may be usefully altered and increased by mixed solvents such as ethanol/water mixtures and/or by altering and controlling the temperature and other conditions under which solvation is achieved. Although it may be possible to obtain an aqueous solution of higher oligomeric materials at low concentration under a number of conditions, and even at usefully high concentrations under other conditions, it may be more practical to prepare a solution of the higher oligomers in ethanol or an ethanol/water mixture containing 20 to 95% by volume of ethanol. Generally, a solution containing of from 1% to 10.0% by weight of oligomeric proantycyanidin, oak extract and other polyphenolics and more usually of from 0.10% to 5% by weight of said oligomers can be prepared in an ethanol/water mixture containing 50% water and 50% ethanol (95%). The concentration of the oligomer in the ethanol/water mixture is not important, as the solution is only a useful vehicle for incorporating a PC or polyphenolics into the food, beverage, or additive mixture to be modified. The actual concentration will generally be dictated by the degree of solubility of the oligomer, the percentage of ethanol in the mixture and the convenience of adding the solution of the oligomer to the food or beverage system.

Examples of various categories of foods and beverages that may be improved modified or altered in taste by the addition of an effective amount of a polyproanthocyanidin or a polyphenolic are mentioned below.

1) Brown Foods—This class of flavors includes coffee, tea, chocolate, maple, and brown sugar. Examples of brown flavors in food systems include: chocolate pudding, yogurt, ice cream, instant coffee, hard candy, chocolate candy, powdered tea drinks, ready to drink teas etc. For lowfat chocolate icing, the flavor changed from cocoa to fudge and increased in intensity. The product was more blended. For lowfat coffee flavored ice cream, the creaminess of the ice cream increased with the addition of MPCs and OPCs. The appropriate amount of a polyphenolic monomeric or oligomeric material, such as a PC or an oak extract, in a brown food is from 0.001% to 0.1% (10 ppm to 1,000 ppm) and more preferably from 0.0025% to 0.05% by weight (25 ppm to 500 ppm).

2) Dairy Products—This class includes such foods as cheeses, yogurt, milk, ice cream, and the like. PCs can add blendedness and creaminess to the various dairy products, while decreasing the sharp notes of the short chain volatile acids. This is especially noticeable in low-fat systems where the milk/dairy notes are enhanced and extended. The effective amount of PPs, (which include PCs or may be derived from oak or similar sources), in a dairy product is from 0.001% to 0.10% (10 ppm to 1,000 ppm) and more preferably from 0.0025% to 0.05% by weight (25 ppm to 500 ppm).

3) Citrus—It was shown that there are some unique advantages with combining OPCs and citrus flavors. By citrus flavors is meant any flavor that is derived from a fruit borne by a tree or shrub of the genus Citrus, which include oranges, lemons, limes and grapefruits. There is a synergy that modifies the flavor from candied to fresh. In some food and beverage systems it is very difficult/impossible to achieve a fresh citrus flavor (high alcohol: 8% and above), dietetic/lowfat, carbonated beverages), therefore the addition of the OPC is a very useful discovery. The effective amount of PPs, (which include PCs or may be derived from oak or similar sources), in citrus products is from 0.001% to 0.10% (10 ppm to 1,000 ppm) and more preferably from 0.0025% to 0.05% by weight (25 ppm to 500 ppm), but a very useful amount of from 10 ppm to 250 ppm and also from 10 ppm to 100 ppm.

The alcoholic beverage systems listed to in Table 1 were used as model systems for the evaluation of the modification properties of MPCs and OPCs when added below the intrinsic sensory taste threshold: white and red wines, brandy, creamed brandy, 6% alcohol flavored wine products. The OPCs and MPCs were screened at levels from 10-100 ppm and proved to be effective beverage modifiers at all concentrations. FIGS. 11-17 depict the alcoholic beverage systems with the addition of 30 ppm OPCs and/or MPCs.

It was found that the OPCs and MPCs could modify the onset of the flavor, change the aromatics associated with the beverage, decrease or increase alcohol perception, add smoothness/blendedness and increase or decrease bitterness. The products were modified as depicted in the FIGS. 11-17 below.

4) Various Grape and Non-Grape Based Alcoholic Beverages—Such low-alcohol beverages as beers, and wines and higher alcoholic content beverages such as brandies, scotch and liquors may be improved or enhanced by the addition of PPs, especially PCs. Illustrative examples of such alcoholic beverages are mentioned below:

(a) The wine category—This area includes both wines at full alcohol (9-14%) and wine-based beverages of lowered alcohol (4-9%), including wine coolers. It is well known that regular wines differ in quality and in taste depending on the type of grapes used to make the wine, the geographic area where the grapes grow, the soil, the amount of sun and rain, the temperature variation, even the temperature during the night, during a certain critical period before the harvest and other variables that can make a particular wine in a particular year great, very good or merely mediocre. For these reasons occasionally some wines may be deficient in some flavor attribute, and it would be most helpful to a winemaker if such a deficiency could be corrected.

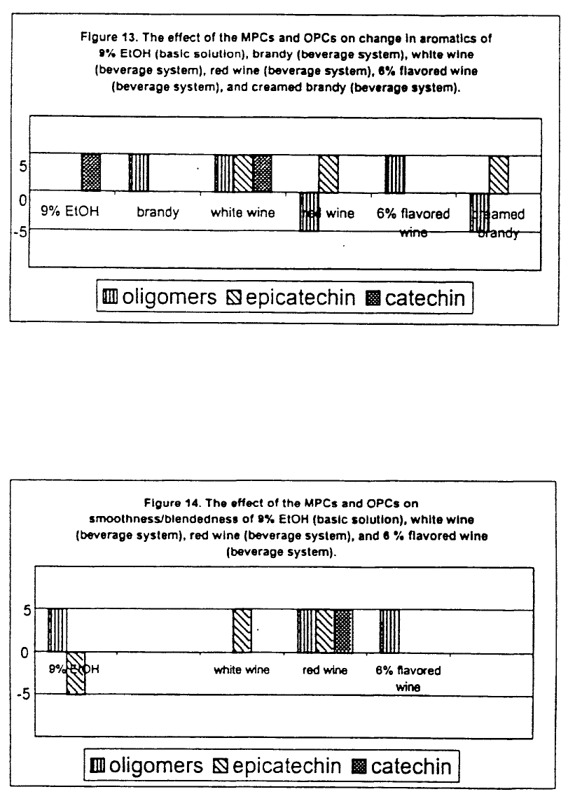

The use of a PP, such as monomeric or oligomeric proanthocyanidin from seed or oak can unexpectedly modify, improve or enhance certain taste, flavor, mouthfeel and other sensory characteristics and especially body to improve the quality of wine. Wines can be made to have increased complexity, taste more blended (FIG. 14), more full-bodied, as well as what is generally described as more aged. (The panelists described the wine with the added PCs as having changed from a red fruit to more of a brown fruit/aged). (FIG. 13 illustrates the change of aromatics for white and red wine with the addition of MPCs and OPCs.

Similarly, a proanthocyanidin or other polyphenolic can alter, generally improve, the body and the mouthfeel of a wine. If, for example, the wine is thin, it can increase the vinous character; if there is a lowered alcohol product and it is high in fruity character, the proanthocyanidin or other monomeric and oligomeric polyphenolic can be added to decrease the sweetness, decrease the fruitiness, while improving the character of the fruity note (from artificial to fresh/real). This may be accomplished by adding to a wine from 0.0001-0.05% by weight (1 ppm to 500 ppm) of a PP, such as a proanthocyanidin or an oak extract, preferably from 0.0005% to 0.025% (5 ppm to 250 ppm) or even 0.0005% to 0.01% (5 ppm to 100 ppm) by weight and most preferably from 5 ppm to 50 ppm. The amount of a proanthocyanidin or other polyphenolic actually added will depend on the type of wine used, the particular feature that is being modified and the desired level of modification in the taste or other sensory characteristic desired. Therefore, certain level of experimentation is necessary in determining the preferred amount of a polyphenol that should be added.

It was mentioned that PPs of different origin or different molecular weight may have different modification/altering effect of certain complex foods or beverages. An example of how the intrinsic properties of the oligomers may differ, depending on the origin of the oligomer, is demonstrated in the following example. When to one sample of Turning Leaf® Cabarnet wine was added 100 ppm of a PP oligomer extracted from cocoa, the perception of alcohol was decreased. However, when 100 ppm of a PP oligomer extracted from pine was added to the second sample of Turning Leaf Cabarnet®, the perception of alcohol was increased. Thus the PP oligomers from both plants modified an alcoholic beverage system, but in a different way.

(b) The low alcohol and flavored wine category—This invention is particularly useful in improving and enhancing the taste and other sensory characteristics of low alcohol or flavored wines. This type of beverages includes wine coolers etc. The low alcohol wine beverages generally will contain from 4% to 9% by volume of alcohol. Such beverages are generally made from wine or malt or other neutral spirit by using, for example from 20% to 80% of wine and the balance may be an appropriate fruit juice or a mixture of fruit juices, water, sugar or other sweeteners such as fructose, corn syrup, invert syrup, refiners syrup, maltose and high maltose syrups and mixtures thereof, and other natural and artificial flavors and colors. These low content wine beverages generally may have a sweet, watery, overly fruity, thin taste without much body and sophistication. By incorporating from about 0.0001 to about 0.05% (1 ppm to 500 ppm) by weight of PP, such as a proanthocyanidin or an oak extract, and more preferably from 0.0005% to about 0.025% (5 ppm to 250 ppm) or even from 0.0005% to about 0.01% (5 ppm to 100 ppm) by weight and most preferably from about 0.0005% to about 0.005% (5 ppm to 50 ppm) by weight of proanthocyanidin in the above described low wine content beverages the above listed deficiencies and other taste and sensory parameters can be substantially improved and enhanced. FIG. 12 illustrates the enhancement of the alcohol perception in a 6% flavored wine with the addition of oligomers.

(c) Spirits—Spirits are high alcohol content beverages, such as brandies, scotch, bourbon and liqueurs, usually containing from about 20% to about 50% by volume of alcohol. Spirits have generally not been the subject of improvement once they have been made. Surprisingly, this invention is capable of improving, modifying and/or otherwise enhancing the quality of this type of an alcoholic beverage, especially smoothness, by incorporating therein an effective amount of a proanthocyanidin or any other polyphenolic. Some brandies, scotch, bourbon and liqueurs, especially the less expensive type, may be somewhat harsh or bitter in taste and have an overpowering and an unpleasant and biting taste of alcohol. The addition of OPC modified and increased the aromatics: vanillin, sweet brown and decreased some of the harsh alcohol burn associated with brandy (FIGS. 13 and 12). The taste and other sensory traits of such alcoholic beverages may be improved and the desirable taste enhanced by the addition of from 0.0001% to about 0.05% by weight (1 ppm-500 ppm) of a PP, such as a proanthocyanidin or an oak extract, and more preferably from about 0.0005% to about 0.010% (5 ppm-100 ppm). Liqueurs and other fruit extract-containing alcoholic beverages may also be improved in taste. The addition of from about 0.0001% to about 0.05% (1 ppm-500 ppm) by weight and more preferably from about 0.0005% to about 0.01% by weight (5 ppm-100 ppm) of proanthocyanidin or any polyphenolic is particularly effective in enhancing and prolonging the taste of the fruit or fruits used to make the liqueur.

When 50 ppm of monomeric PC was added to the following brandies: E. & J.® Brandy (California), Remy Martin® Cognac VSOP (French), J. Dupery® Armagnac a marked improvement in the quality of taste of the brandies is noticed. The brandies samples with PC were smoother, had less alcohol bite and tasted milder.

(d) High alcohol, cream based products—Creamed Brandy can also be enhanced with the addition of the OPCs. Creaminess can be increased aromatics altered, and a decrease in alcohol perception can be achieved with the addition of MPCs and OPCs (FIG. 16, 13, 12). The taste and other sensory traits of such alcoholic beverages may be improved and the desirable taste enhanced by the addition of from 0.0.0001% to about 0.0.50% by weight (1 ppm-500 ppm) of an MPC or OPC, such as a proanthocyanidin or an oak extract, and more preferably from 0.0005% to about 0.025% (5 ppm-250 ppm) and often from about 0.0005% to about 0.010% (5 ppm-100 ppm).

5. Dietetic or Low Fat or Fat-Free Foods—These foods of many types can particularly benefit from the present invention. The low fat or fat-free desserts include frozen desserts, such as ice cream, ice milk, sherbet, frozen yogurt, frozen custard, sorbet, ices, tofuti and imitation ice cream. Other dietetic desserts may include, for example, puddings, mousse, cakes, pies, gelatin desserts and the like. To reduce the caloric content of a dessert, generally an artificial sweetener is substituted for sugar (sucrose). However, in desserts sugar provides not only sweetness but it also acts as a bulking agent. Since, for example, the artificial sweetener aspartame is about 200 times as sweet as sugar, it would be easy to replace all the sugar in the desserts by adding a relatively small amount of aspartame. The reduction of volume would, however, have a deleterious effect on the structure of the dessert, causing the mouthfeel to be inferior. For this reason whenever all or most of the sugar is replaced by an artificial sweetener, it is necessary to replace the bulk normally provided by the sugar by substitute bulking agents. Available bulking agents are carbohydrates which cannot be metabolized, such as polydextrose alone or in combination with minor amounts of sugar alcohol or enzymes such as rennet, carboxymethyl cellulose or carboxyethylcellulose, tofu (soybean protein) and others that are well known in the art. The effective amount of PPs, (which include PCs or may be derived from oak or similar sources), in a dietetic or low fat or fat-free food product is from 0.001% to 0.10% (10 ppm to 1,000 ppm) and more preferably from 0.0025% to 0.05% by weight (25 ppm to 500 ppm) or even from 25 ppm to 250 ppm.

Traditional desserts normally contain a substantial amount of fats which provide a pleasant mouthfeel and creaminess to a dessert. In low-fat or fat-free desserts the fat is usually substituted by low caloric fats, such as Lipifats, sucrose polyesters (a mixture of hexa-, hepta- and octa-esters formed by the reaction of sucrose with long chain fatty acids) and other low or non-caloric materials known to the trade. These non or low-caloric fats and sucrose polyesters are not metabolized and are thus a means to reduce the caloric content of a dessert. The bulking agents and the fat substitutes, however, do not provide the creaminess and the mouthfeel that are present in a traditional dessert. The dietetic desserts, whether frozen or in other forms, generally possess unpleasant, chalky, sometimes somewhat gritty mouthfeel, taste, and texture. The addition of from 50 to 250 ppm or even from 50 to 100 ppm of a PP, in this case the PC monomer, increases creaminess and body and decreases chalky and thin off notes.

Basic tastes are sweet, sour, salty, umami, bitter. The psychophysics of the basic tastes is such that the relative threshold of the tastants is different, and their perception changes with concentration. However, the current invention modulates the perception of the basic tastes at levels above the threshold of the taste being modified and below the threshold of the PPs.

Modulation of Sourness: For salad dressing, sourness was shown to decrease with the addition of OPCs and MPCs (FIG. 8).

Modulation of Sweetness: In complex food systems, the OPCs were found to decrease sweetness for lemon icing and jelly (FIG. 7). Epicatechin and Catechin (the MPCs) had no effect.

Modulation of Saltiness: In complex food systems, saltiness was found to be increased by the addition of MPCs (FIG. 6). Catechin strongly increased the perception of saltiness in both salad dressing and cheese. Epicatechin strongly increased the perception of saltiness in cheese.

The benefits of this invention are useful not only in various foods consumed by humans but similarly in foods intended for animals, such as in dog foods, cat foods, food preparations for larger animals such as cows or horses and other animals.

Thus by adding the above mentioned amount of a polyphenolic monomeric or oligomeric material or a mixture thereof or a mixture of such monomeric and/or oligomeric materials with up to 0.1% of a polymeric polyphenolic material, one can modify aromatics, blendedness, creaminess, mouthfeel, fullness, saltiness, sourness, bitterness, onset of initial flavor perception or alcohol perception in foods, dairy products, citrus, alcoholic beverages, dietetic foods, low fat foods or fat-free foods. The various polyphenolic materials preferably are extracted from grape seeds.

### EXAMPLE 1

### Preparation of Crude Grape Seed Extract from Vitis Vinifera

Vitis vinifera seed (4 Kg.) were ground and macerated for 5 hours with 8 liters of aqueous 80% ethanol at room temperature. The solvent was drained from the seeds and the maceration repeated three times. The aqueous-ethanol extracts were combined, concentrated under vacuum to remove ethanol, lyophilized to remove water, and yielded crude grape seed extract.

### EXAMPLE 2

### Isolation of Monomers/Oligomers

Crude grape seed extract (100 g) was ground using a mortar and pestle, placed in a 1 L Erlenmeyer flask, and sonicated with 1 L of 95% ethanol for 30 minutes. The mixture was stirred, placed in a 40° bath for 1 hour, and centrifuged at 10,000 rpm for 10 minutes to remove undissolved particulates. The supernatant was decanted into a 2 L Erlenmeyer flask. Hexane (1000 mL) was added with stirring to the decanted ethanolic solution, and the mixture permitted to stand for 20 minutes to effect complete precipitation. The Erlenmeyer now contained insoluble polymeric polyphenolic materials, and ethanol rich supernatant containing the monomeric and oligomeric polyphenols, and a hexane rich supernatant. Both supernatants were decanted from the insoluble polymeric polyphenolic materials.

The hexane rich supernatant was discarded. The ethanol rich supernatants was concentrated in vacuo and lyophilized to remove the solvents. The remaining solid is a mixture of monomeric and oligomeric polyphenols which may be employed in the method of this invention to modify taste characteristics as described above. If it is desired to separate monomers from oligomers the below described procedure using chromatography may be employed.

A chromatography column packed with a suitable absorbent (styrene/divinylbenzene, activated carbon, zeolites, an ion exchange resin or other suitable absorbent). The aqueous solution of crude monomers/oligomers mixture is applied to the top of the column. Thereafter the column is first eluted with water that may contain up to 10% of ethanol to remove certain water soluble impurities (such as sugars).

Thereafter the polarity of the eluent is decreased by adding to water 10% to 20% of ethanol. The column is eluted with this alcoholic solution to isolate substantially monomers.

The polarity of the eluent is decreased again by adding additional 10% to 20% of ethanol and the column is eluted with this alcoholic solution to isolate primarily oligomers.

The monomers and oligomers isolated as described above will contain a small amount of impurities (5% to 10%) including oligomers or monomers. If a more pure monomer or oligomer material is desired, the above described procedure may be repeated one or more times.

The above described extraction, separation and purification methods can also be used for the preparation of PPCs from various Plant sources other than grape seeds to demonstrate a universal application of the extraction, fractionation and purification methods. The monomeric and oligomeric polyphenolic materials can be similarly extracted and purified from oak as well as from pine bark, cocoa powder, black tea and green tea according to the methods of Examples 1 to 3. The monomeric/oligomeric polyphenol materials from these natural sources have similar physical properties to the PPCs extracted from grape seeds and also exhibit similar effect on the modification of taste flavor of various foods and beverages.

One skilled in the art will understand that many variations and alterations are possible within the scope of the invention. Therefore, the invention in its broader aspects is not limited to the specific details and representative examples described herein. Accordingly, various modifications may be made without departing from the spirit or scope of the general inventive concept as defined by the appended claims and their equivalents.

What is claimed is:

1. A method of modifying aromatics, blendedness, creaminess, mouthfeel, fullness, saltiness, sourness, bitterness, onset of initial flavor perception or alcohol perception in a prepared compound food or beverage by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials or (d) a mixture of any or all of said polyphenolic materials with a polymeric polyphenolic material.

2. A method of claim 1, wherein the polyphenolic material is used in an amount of from about 0.0005% to about 0.05% based on the amount of the food or beverage.

3. A method of claim 1, wherein the food or beverage is brown foods, dairy products, citrus, alcoholic beverages, dietetic foods, low fat foods or fat-free foods.

4. A method of claim 3, wherein said polyphenolic materials contain flavan-3-ol or hydroxyflavan-3,4-diol structural units.

5. A method of modifying aromatics, blendedness, creaminess, mouthfeel, fullness, saltiness sourness, bitterness, onset of a flavor perception or alcohol perception in a prepared compound food or beverage, by incorporating therein from about 0.0001% to about 0.10% by weight of a polyphenolic material isolated from a grape material.

6. A method of claim 5, wherein the polyphenolic material is used in an amount of from about 0.0005% to about 0.05%.

7. A method of claim 5, wherein the grape material is grape seeds.

8. A method of claim 7, wherein the polyphenolic material is primarily monomeric or loigomeric or a mixture thereof.

9. A method of claim 7, wherein the polyphenolic material is primarily a mixture of monomeric or oligomeric with up to 0.1% of polymeric polyphenolic material or a mixture of monomeric and oligomeric with up to 0.1% of polymeric polyphenolic material.

10. A method of claim 5, wherein the food or beverage is brown foods, dairy products, citrus, alcoholic beverages, dietetic foods, low fat foods or fat-free foods.

11. A method of modifying of aromatics in a prepared compound food or beverage by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

12. A method of claim 11, wherein the food or beverage is brown foods, dairy products, citrus alcoholic beverages, dietetic foods, low fat foods or fat-free foods.

13. A method of claim 12, wherein the polyphenolic material is used in an amount of from about 0.0005% to about 0.05%.

14. A method of claim 11, wherein the polyphenolic material is isolated from a grape material.

15. A method of claim 14, wherein the grape material is grape seeds.

16. A method of modifying blendedness in a prepared compound food or beverage by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

17. A method of claim 16, wherein the food or beverage is brown foods, dairy products, citrus, alcoholic beverages, dietetic foods, low fat foods or fat-free foods.

18. A method of claim 17, wherein the polyphenolic material is used in an amount of from about 0.0005% to about 0.05%.

19. A method of claim 16 wherein the polyphenolic material is isolated from a grape material.

20. A method of claim 19, wherein the grape material is grape seeds.

21. A method of modifying of mouthfeel in a prepared compound food or beverage by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

22. A method of claim 21, wherein the food or beverage is brown foods, dairy products, citrus, alcoholic beverages, dietetic foods, low fat foods or fat-free foods.

23. A method of claim 22, wherein the polyphenolic material is used in an amount of from about 0.0005% to about 0.05%.

24. A method of claim 21, wherein the polyphenolic material is isolated from a grape material.

25. A method of claim 24, wherein the grape material is grape seeds.

26. A method of modifying creaminess in a prepared compound food or beverage by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

27. A method of claim 26, wherein the food or beverage is brown foods, dairy products, citrus, alcoholic beverages, dietetic foods, low fat foods or fat-free foods.

28. A method of claim 27, wherein the polyphenolic material is used in an amount of from about 0.0005% to about 0.05%.

29. A method of claim 26, wherein the polyphenolic material is isolated from a grape material.

30. A method of claim 29, wherein the grape material is grape seeds.

31. A method of claim 26, wherein the food is a dietetic food.

32. A method of claim 26, wherein the food is a low fat food.

33. A method of claim 26, wherein the food is a fat-free food.

34. A method of modifying of fullness in a prepared compound food or beverage by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

35. A method of claim 34, wherein the food beverage is brown foods, dairy products, citrus, alcoholic beverages, dietetic foods, low fat foods or fat-free foods.

36. A method of claim 35, wherein the polyphenolic material is used in an amount of from about 0.0005% to about 0.05%.

37. A method of claim 34, wherein the polyphenolic material is isolated from a grape material.

38. A method of claim 37, wherein the grape material is grape seeds.

39. A method of modifying of saltiness in a prepared compound food or beverage by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

40. A method of claim 39, wherein the food is of brown foods, dairy products, citrus, dietetic foods low fat foods and fat-free foods.

41. A method of claim 40, wherein the polyphenolic material is used in an amount of from about 0.0005% to about 0.05%.

42. A method of claim 39, wherein the polyphenolic material is isolated from a grape material.

43. A method of claim 42, wherein the grape material is grape seeds.

44. A method of modifying of sourness in a prepared compound food or beverage by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

45. A method of claim 44, wherein the food is brown foods, dairy products, citrus, dietetic foods, low fat foods or fat-free foods.

46. A method of claim 45, wherein the polyphenolic material is used in an amount of from about 0.0005% to about 0.05%.

47. A method of claim 44, wherein the polyphenolic material is isolated from a grape material.

48. A method of claim 47, wherein the grape material is grape seeds.

49. A method of modifying of bitterness in a prepared compound food or beverage by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

50. A method of claim 49, wherein the food or beverage is of brown foods, dairy products, citrus, alcoholic beverages, dietetic foods, low fat foods or fat-free foods.

51. A method of claim 50, wherein the polyphenolic material is used in an amount of from about 0.0005% to about 0.05%.

52. A method of claim 49, wherein the polyphenolic material is isolated from a grape material.

53. A method of claim 52, wherein the grape material is grape seeds.

54. A method of modifying of the initial onset of flavor perception in a prepared compound food or beverage by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

55. A method of claim 54, wherein the food or beverage is brown foods, dairy products, citrus, alcoholic beverages, dietetic foods, low fat foods or fat-free foods.

56. A method of claim 55, wherein the polyphenolic material is used in an amount of from about 0.0005% to about 0.05%.

57. A method of claim 54, wherein the polyphenolic material is isolated from a grape material.

58. A method of claim 57, wherein the grape material is grape seeds.

59. A method of modifying of alcohol perception in a high alcohol-content beverage, a low alcohol-content beverage or a flavored wine by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

60. A method of claim 59, wherein the polyphenolic material is used in an amount of from about 0.0005% to about 0.05%.

61. A method of claim 59, wherein the polyphenolic material is isolated from a grape material.

62. A method of claim 61, wherein the grape material is grape seeds.

63. A method of modifying smoothness in a high alcohol-content beverage by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

64. A method of claim 63, wherein the polyphenolic material is used in an amount of from about 0.0005% to about 0.05%.

65. A method of claim 64, wherein the polyphenolic material is isolated from a grape material.

66. A method of claim 65, wherein the grape material is grape seeds.

67. A method of claim 64, wherein the beverage is a brandy.

68. A method of modifying of alcohol perception, blendedness, smoothness, fullness or mouthfeel in a low alcohol-content beverage or a flavored wine by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

69. A method of claim 68, wherein the polyphenolic material is used in an amount of from about 0.0005% to about 0.05%.

70. A method of claim 68, wherein the polyphenolic material is isolated from a grape material.

71. A method of claim 70, wherein the grape material is grape seeds.

72. A method of claim 68, wherein the polyphenolic material is isolated from an oak material.

73. A method of claim 72, wherein the polyphenolic material is used in an amount of from about 0.0005% to about 0.05%.

74. A method of modifying of blendedness, smoothness, fullness or mouthfeel in a low fat food or a fat-free food by incorporating therein from about 0.0001% to about 0.10% by weight of a polyphenolic material selected from (a) a monomeric polyphenol, (b) an oligomeric polyphenol, (c) a mixture of monomeric and oligomeric polyphenolic materials and (d) a mixture of any or all of said polyphenolic materials with a polymeric polyphenolic material.

75. A method of claim 74, wherein the polyphenolic material is used in an amount of from about 0.0005% to about 0.05%.

76. A method of claim 74, wherein the polyphenolic material is isolated from a grape material.

77. A method of claim 76, wherein the grape material is grape seeds.
